(19) United States
(12) Patent Application Publication
(10) Pub. No.: US 2013/0097484 A1
(43) Pub. Date: Apr. 18, 2013

(54) METHOD AND SYSTEM OF OPERATION RETRIEVAL FOR WEB APPLICATION

(71) Applicant: Tomohiro Nakamura, Hachioji-shi (JP)

(72) Inventor: Tomohiro Nakamura, Hachioji-shi (JP)

(73) Assignee: Hitachi Ltd.

(21) Appl. No.: 13/806,606

(22) PCT Filed: Sep. 1, 2010
(86) PCT No.: PCT/JP2010/005386

§ 371 Date: Dec. 21, 2012

(30) Foreign Application Priority Data
Jun. 25, 2010 (JP) 2010-144998

(51) Int. Cl. G06F 17/21

(52) U.S. Cl. CPC G06F 17/218
USPC 715/234

(57) ABSTRACT

Operation retrieval of webpage which includes content that actively changes on client side. When transmitting a webpage to a web browser, a web server detects an operation log acquisition function operating in the client's browser, detects web page text layout changes, and inserts and transmits a saved difference detection function. Web browser executes the difference detection function that was inserted in the web page that was received and saves the text layout of the webpage as a first text layout. Web browser executes the operation log acquisition function and generates and saves the operation log for web page, executes the difference detection function, compares text layout of webpage and first text layout, and if there is a disparity, makes a link between the disparity and the operation log. The log coordination server retrieves the operation of the web application, using the disparity that was linked to the operation log

### TECHNICAL FIELD

The present invention relates to an operation reproduction processing technology that records and reproduces an operation of a web application.

### BACKGROUND ART

In recent years, various services have been provided through the use of a web application. This is very convenience because a user needs to prepare only a web browser when using the web application. The web application may provide a service on the web by distributing a lightweight script language or providing a development environment having fulfilled function at low cost so that an expressive web application with various functions is developed even though a user is not an expert or a big company which has rich resources. Further, a user participation type web service appears, which dynamically changes contents on the web in many cases. Due to immediacy of information or information which is obtained from various sources, a usage scene of the web service becomes broader.

From the above-mentioned background, in workplace or social life, the web application is widely used and the usability of the web application largely affects the working efficiency or success or failure of a business. Therefore, a service provider that uses the web application is very interested in the usability of the web application.

In a related art, the web application assigns separate web pages into individual information or jobs and performs a processing including a series of provided information or a plurality of jobs by the transition of a web page. Therefore, by analyzing an access log to a web server that performs the web application, the transition of the web page is recognized and a usage method of the web application is partly understood. However, in recent years, by a method that embeds a script language in a web page, it is possible to dynamically change the displayed contents on the web page and provide large quantity of information in one page of web page or make a plurality of jobs available. Therefore, a method of using the web application becomes highly complicated. It is difficult to sufficiently understand the method of using the highly complicated web application by the access log of the web server in which only a record in the unit of web page remains. Accordingly, a technology that records and stores the web application in the unit of operation on the web page which is smaller than the unit of web page to playback and check the web application is required.

In accordance with this requirement, as a related art, a method that captures an operation of the web application by videotaping and playing back the operation is frequently used. However, there is a problem in that this method is not suitable for a continuous and large quantity recording and playback. Further, a method that installs a moving is image capture tool that captures a screen on a client device in which a web browser browsing a web page operates to perform recording and playback also has a problem in which it takes time to perform playback. As a technology similar to the moving image capture tool, instead of capturing the screen, a tool that records an operation log on the client device is suggested. However, this technology requires an installation onto the client device, which is similar to the moving image capture tool. Therefore, it is difficult to introduce this technology in an environment such as Internet. Further, even though the operation log on the web page may be recorded using a lightweight script language, if a document structure of a web page is dynamically changed, it is difficult to increase the reproducibility of the operation.

In contrast, Patent Literature 1 discloses a method that stores an accessible history for accessible dynamic contents so as to combine an operation event with a property of an object to be operated as a set and actually performs the operation event to dynamically change the operation event to be reproduced, by operating a form on a web browser screen.

Further, Patent Literature 2 discloses an event recording and playing-back apparatus that records and plays back an input operation procedure by an operator of a web page in a script file and a method that reproduces and performs an input operation procedure also in a changed web page based on the difference extracted from a difference extracting unit of a web page at the time of recording and playing-back and a script file.

In addition, Patent Literature 3 discloses a method that collects a packet at the time of communication occurring in accordance with the operation and reproduces a screen of a terminal based on the packet even when contents which dynamically are changed in accordance with the operation of a user are displayed on the terminal.

### CITATION LIST

### Patent Literature

Patent Literature 1: Japanese Patent Application Laid-Open Publication No. 2001-060179
Patent Literature 2: Japanese Patent Application Laid-Open Publication No. 2004-287929
Patent Literature 3: Japanese Patent Application Laid-Open Publication No. 2009-176124

### SUMMARY OF INVENTION

### Technical Problem

However, Patent Literature 1 may not be applied to a case which cannot be actually performed such as time dependent contents which are not reproduced by actual performance or a transfer processing. Further, an object of the method of Patent Literature 2 is to perform an operation recorded on a changed document even when a document which is loaded from a server is changed but is not to reproduce an environment where the operation is recorded. Further, when the difference extraction is difference extraction in the unit of document and the operation is dynamically changed at the client side, the operation is not reproduced. Further, Patent Literature 3 has problems in which the packet is not generated and the screen cannot be reproduced when the screen is changed only at the client side.

On the basis of the above-description, the problems to be addressed by the present invention are as follows.

One object of the present invention is to precisely reproduce the operation of a web page including contents which are dynamically changed at the client side. Further, another object is to precisely reproduce the operation not by a low extensible method which requires a large quantity of storage areas for storing a log of the contents which are dynamically changed, but by an efficient and highly extensible method. Further, also another object is to perform reproduction without aggressively and actually performing an operation at the time of reproducing the web operation.

In order to improve the reproducibility of the operation of the web page including contents which are dynamically changed at the client side, for now, it has been required to store logs for all contents every operation using a large quantity of storage area or actually and dynamically change the contents by actually performing the operation.

Therefore, it is difficult to continuously leave multiple records in order to use a large quantity of resources or unnecessary changes of the status of the server side, for example, an adverse effect caused by the actual performance may be added. Therefore, the object of the invention is to address the above-mentioned problems.

Specifically, an object of the present invention is to provide an operation reproduction method and system for a web application in order to increase the reproducibility of the operation on a web page which is dynamically changed.

### Solution to Problem

The present invention has been made in an effort to provide an operation reproduction method and system for a web application in a system configured by a web server, a web browser, a log connection server that stores an operation log on the web page, and a network that couples the web server, the web browser, and the log connection server to each other. The web server inserts an operation log acquisition function that operates on the web browser and a difference detection function that detects and stores change of a document structure of the web page in the web page and transmits the functions when the generated web page is transmitted to the web browser, the web browser performs the difference detection function inserted in the received web page to store the document structure of the web page as a first document structure, the operation log acquisition function is performed to generate and stores the operation log on the web page, the difference detection function is performed to compare the document structure of the web page with the first document structure and if there is a difference, the difference is stored so as to be associated with the operation log, and the log connection server reproduces the operation using the stored operation log and the difference which is stored to be associated.

Further, in order to achieve the object, in the operation reproduction method and system for a web application according to an exemplary embodiment of the invention, in the web server in which the web application operates, the web application inserts a function that stores a client device or a user that requests the generated web page and a unique identifier to the web page, determines whether there is a request from the outside to transmit the stored operation log in accordance with the request. Further, an interface that displays and selects a list of the identifiers stored at the web server side is provided. The client device that has an operation related to the selected identifier determines the selected content so that an operation is selectively collected and played from a plurality of user operation logs. With respect to a web page including a content which is dynamically changed, if the content is dynamically changed at the server side, the web server stores the content of the web page included in the response so as to be associated with the identifier and the stored content is used at the time of playing back the operation. Therefore, the dynamic content is appropriately played.

In the meantime, if the content is dynamically changed at the client device side, a function that checks the document structure of the web page in accordance with the operation on the web browser or the elapsing time, detects the difference from the document of the web page transmitted from the server, and stores the document structure so as to be associated with the operation log is inserted in the web page and stored. Further, at the time of reproducing the operation, the operation on the stored web page is reproduced by reflecting the difference of the document structure of the stored web page so as to be associated with the operation into the web page that performs the reproduction.

Further, when the difference detection function detects the dynamic change of the web page, instead of storing the difference of the document structure, a flag indicating that there is dynamic change is stored so as to be associated with the operation. At the time of reproducing the operation on the web page, when the operation which is dynamically changed is played, only the operation is actually performed so as to improve the precision of the reproduction of the operation.

### Advantageous Effect of Invention

According to the present invention, it is possible to precisely reproduce an operation on a web page which is dynamically changed without consuming a large quantity of resources.

### BRIEF DESCRIPTION OF DRAWINGS

FIG. 1 is a view illustrating a configuration of a system that executes a web application for various embodiments.

FIG. 2 is a view of an operation reproduction processing flow of the web application for various embodiments.

FIG. 3 is a processing flowchart of operation recording according to a first embodiment.

FIG. 4 is a view illustrating an example of a document structure of a web page according to the first embodiment.

FIG. 5 is a view illustrating an operation log according to the first embodiment.

FIG. 6 is a processing flowchart of operation recording according to a second embodiment.

FIG. 7 is a processing flowchart of operation recording according to a third embodiment.

FIG. 8 is a processing flowchart of operation recording according to a fourth embodiment.

FIG. 9 is a processing flowchart of operation recording according to a fifth embodiment.

FIG. 10 is a processing flowchart of operation recording according to a sixth embodiment.

FIG. 11 is a processing flowchart of operation playback according to the first embodiment.

FIG. 12 is a sequence view of operation playback according to the first embodiment.

FIG. 13 is a view illustrating an example of a web page that selects a web page to be operated and reproduced according to the first embodiment.

FIG. 14 is a view illustrating an example of a web page that selects an operation to be operated and reproduced according to the first embodiment.

FIG. 15 is a view illustrating the operation reproduction and an example of a web page that controls the operation reproduction according to the first embodiment.

FIG. 16 is a view illustrating the operation reproduction and an example of a web page that controls the operation reproduction according to a modified embodiment of the first embodiment.

FIG. 17 is a view illustrating a configuration example of a system that executes a web application for a seventh embodiment.

FIG. 18 is a processing flowchart of operation recording according to the seventh embodiment.

### DESCRIPTION OF EMBODIMENTS

Hereinafter, various embodiments of the present invention will be described with reference to the drawings. In this description, various devices in a system such as a server device, a client device, an external playback device or an external device will be described. These devices include a general configuration of a computer and are also configured of a processing unit such as a processor, a storage unit such as a memory or a local disk, an input and output unit such as a display, a keyboard, or a mouse, and a networking interface. Various programs are executed on the processor which is a processing unit, and a state where the program is executed is called a module, and for example, when a web browser program is executed on the processor, it is called a web browser module. Further, each of the programs may be called a code, a function, or a functional module.

### First Embodiment

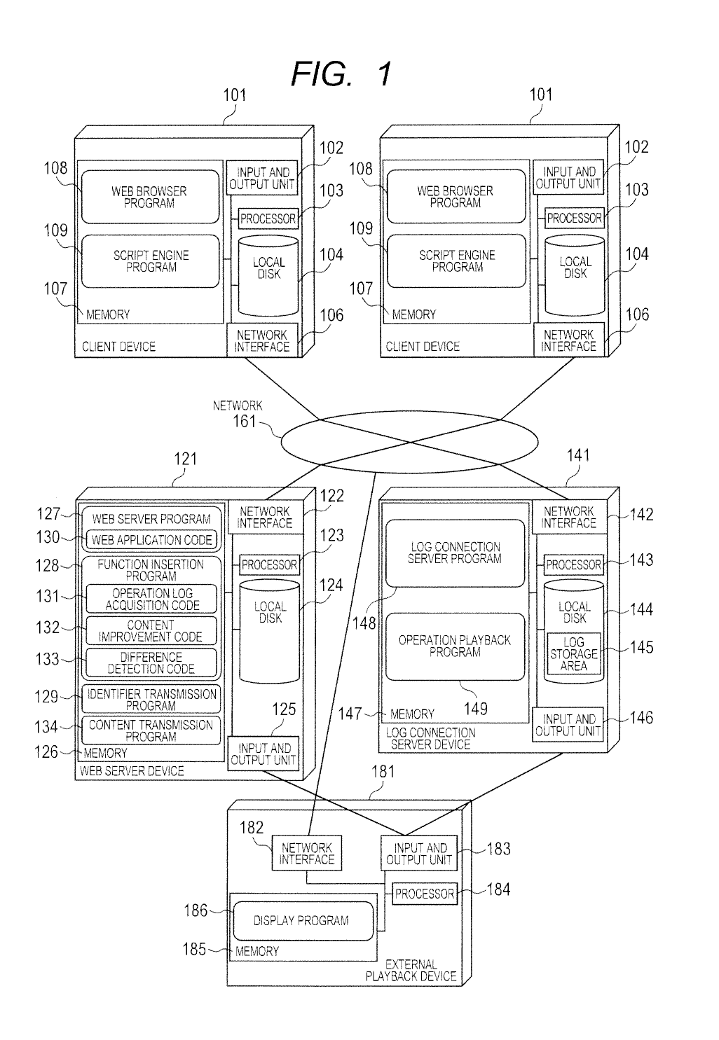

A method of recording and playing back an operation of a web application according to a first embodiment will be described with reference to FIGS. 1 to 5. FIG. 1 is a system configuration view illustrating an example of a hardware configuration and a software configuration of a system that executes a web application for various embodiments.

In FIG. 1, the hardware of the system includes a client device 101, a web server device 121, a log connection server device 141, an external playback device 181, and a network 161 which connects the above-mentioned devices. Further, hardware of each of the devices may be implemented by the same hardware or may be configured by a plurality of hardwares.

The client device 101, the web server device 121, the log connection server device 141, and the external playback device 181 all include processors 103, 123, 143, and 184, memories 107, 126, 147, and 185, input and output units 102, 125, 146, and 183, and network interfaces 106, 122, 142, and 182, respectively and are connected to each other. The client device 101, the web server device 121 and the log connection server device 141 further include local disks 104, 124, and 144. Some of the devices may not have some of the above-mentioned components.

A web browser program 108 and a script engine program 109 accompanied therewith are stored in the memory 107 of the client device 101. Further, these programs are read and executed by the processor 103. The web browser program 108 has a function that requests a web page or receives a response of the requested web page and interprets the response to generate a display screen. The script engine program 109 has a function that interprets a script code included in the response of the web page to allow a processor 103 to execute a processing which is written in the script code.

In the meantime, the script engine program 109 accompanied with the web browser program 108 may be loaded within the web browser program 108. Therefore, in this description, it should be understood that in the web browser program or web browser module, the script engine program or the script engine module may be loaded therein or accompanied therewith.

The keyboard, the mouse, or the monitor is connected to the input and output unit 102 to be used to instruct to execute or stop a program and display the execution result of the program on the monitor.

The processor 103 reads the program from the memory 105 and executes a processing. The network interface 106 transmits/receives a request or a response to/from a web server device or an operation log, to/from an external device of the client device 101 through the network 161.

A web server program 127, a function insertion program 128, an identifier transmission program 129, and a content transmission program 134 are stored in the memory 126 of the web server device 121. These programs may have an inclusive relationship with each other, and for example, the identifier transmission program 129 may be included in the web server program 127. A web application code 130 is included in the web server program 127 or provided in parallel to the web server program 127. In the function insertion program 128, an operation log acquisition code 131, a content improvement code 132, and a difference detection code 133 are included. These programs are read and executed by the processor 123.

The web server program 127 has a function that generates and returns a response of a web page in response to a request from an external device such as the client device 101. The function insertion program 128 has a function that adds or corrects contents included in the response of the web page.

The identifier transmission program 129 has a function that generates or acquires an identifier related to the web page generated by the web server program 127 to transmit the identifier to the external device. As the identifier related to the web page, an ID having a unique value for every request of the web page or an ID that specifies a request source of the web page are included.

The content transmission program 134 has a function that transmits the contents of the web page created by the web server program 127 to the external device. The web server program 127 also has a function that transmits the contents of the web page to the client device which is a request source. However, the content transmission program 134 may also transmit contents to an external device other than the request sources such as the log connection server device 141 or the external playback device 181. In this case, the content transmission program 134 transmits the contents so as to be associated with the identifier related to the web page.

The input and output unit 125, the processor 123, and the network interface 122 have the same functions as devices having the same names in the client device 101. In the local disk 124, all or some of web pages are saved.

In the memory 147 of the log connection server device 141, a log connection server program 148 and an operation playback program 149 are stored. These programs are read and executed by the processor 143.

The log connection server program 148 receives a web page transmitted from the client device 101 or the web server device 121 or an identifier that specifies a request source of the web page, or data such as an operation log, and stores the web page, the identifier, and the data in a log storage area 145 of the local disk 144, reads data on the log storage area 145 or the memory 147, displays lists thereof, or selects a specific identifier or operation log to transmit the specific identifier or operation log to the external device. Further, an operation log related to the specific identifier is transmitted to the external device. The operation playback program 149 provides a function that plays back the operation on the web page from the contents and the operation log of the web page on the external playback device in response to the request from the external playback device 181. The local disk 144 includes the operation log storage area 145 that stores the identifier or the operation log.

The input and output unit 146, the processor 143, and the network interface 142 have the same functions as devices having the same names in the web server device 121.

A display program 186 is stored in the memory 185 of the external playback device 181. The display program 186 is read and executed by the processor 184.

The display program 186 displays a web page, which is similar to the web browser program 108 and the script engine program 109 of the client device 101. However, by the operation playback program 149 of the log connection server device 141, the display program 186 plays back the operation on the web page or temporally stop the playback in connection with the operation log. The input and output unit 183, the processor 184, and the network interface 182 have the same functions as devices having the same names in the web server device 121.

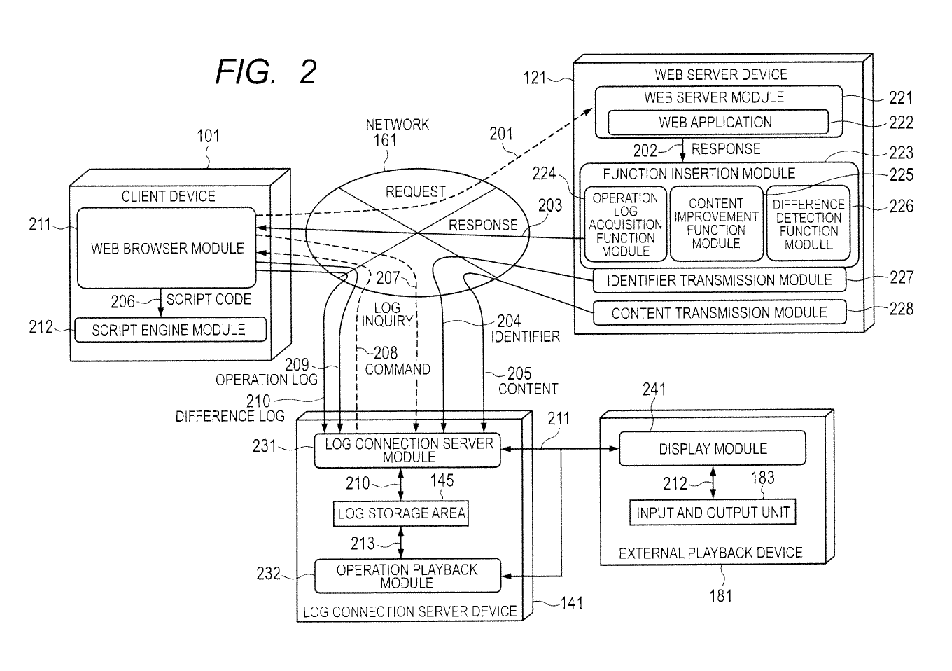

Referring to FIG. 2, a flow of operation reproduction processing of the web application in the system configuration will be described.

As described with reference to FIG. 1, in the system in which the client device 101, the web server device 121, and the log connection server device 141 are connected through the network 161, the client device 101 transmits a request of a web page, the web server device 121 generates and returns a response of the requested webpage, and the client device 101 displays the web page and executes the script code. In the log connection server device 141, an identifier related to the web page, contents of the web page or an operation log on the web page is accumulated. Further, between the log connection server device 141 and the client device 101, the transmission and reception of the operation log or exchange of a command that transmits an inquiry for controlling the log operation and control contents is performed. The external playback device 181 receives the contents and the operation log of the web page from the log connection server device 141 to playback operation on the web page.

Hereinafter, a series of processings will be described in sequence. Further, in FIG. 2 and subsequent drawings, a state where a program is executed on a processor is referred to as a module, and for example, when the web browser program is executed on the processor, this state is referred to as a web browser module.

At first, in FIG. 2, a web browser module 211 of the client device 101 transmits a request of the web page to the web server device 121 via the network 161. The request 201 includes at least an URI (uniform resource identifier) that designates a location where a web page is present. In the web server device 121, a web server module 221 receives the request and a web application 222 that performs a processing in accordance with the web application code 130 generates a response 202 of a requested web page.

The response 202 is transmitted to the web browser module 211 of the client device 101 via a function insertion module 223 included in the web server device 121. An operation log acquisition function module 224 of the function insertion module 223 is included in the client device 101 and inserts a function that acquires the operation log on the web browser module 211 into the response 202 in the form of a script code 206 which is executed on the script engine module 212 accompanied with the web browser module 211 into the response 202. A content improvement function module 225 has a function that changes a part of contents included in the response 202 and inserts an identifier related to the response into the contents. A difference detection function module 226 inserts a function that detects, records, and stores a dynamic change of a document that provides the screen display or a function on the web browser module 211 into the response 202 in the form of a script code 206 that is executed on the script engine module 212 included in the client device 101.

In the web server device 121, an identifier transmission module 227 generates or acquires an identifier 204 related to the response 202 of the web page to transmit the identifier to the log connection server device 141. Further, a content transmission module 228 transmits contents 205 of a web page included in the response 202 to the log connection server device 141. These operations may be sequentially or simultaneously performed.

In the client device 101, the web browser module 211 displays contents included in a response 203, transmits a next request is transmitted in response to the operation, or the script engine module 212 executes the script code 206 included in the contents. The script code inserted by the operation log acquisition function module 224 is executed by the script engine module 212 and an operation log on the web browser module 211 is generated. The generated operation log is stored on the memory 107 or the local disk 104 of the client device 101 together with the identifier. In the operation log acquisition function module 224, a function that inquires a transmission request of the operation log or the log operation request to the log connection server device 141 through the web browser module 211 is included. If the command 208 is returned in response to the inquiry, the operation log which is stored in the memory 107 or the local disk 104 is transmitted to the log connection server device 141 or the operation log is deleted in accordance with the command 208. The command 208 also includes processings other than the log transmission or the log deletion.

In the log connection server device 141, a log connection server module 231 receives the identifier 204 and the contents 205 from the web server device 121 and stores the identifier 204 and the contents 205 in the log storage area 145. Further, list data of the stored identifier 204 is displayed on the external playback device 181 to generate a command that allows the client device to transmit the operation log of the web page related to the selected identifier and transmit the command 208 of the log transmission in response to the log inquiry 207 from the client device 101 to receive an operation log 209 from the client device and store the operation log 209 in the log storage area 145. As described above, the command 208 includes a command for performing processings other than the log transmission. An operation playback module 232 has a function that transmits contents or the operation log of the web page which are stored in the log storage area 145 of the log connection server device 141 and the document structure associated with the operation log to the external playback device 181 to display the operation state in accordance with the operation log on the web page, on the external playback device 181.

In the external playback device 181, a display module 241 communicates with the log connection server device 141 and displays the list of the identifier stored in the log connection server device 141 and selects a specific identifier by the input from the input and output unit 183 to notify the identifier to the log connection server device 141 or displays the operation state on the web page through the operation playback module 232 of the log connection server device 141 or changes the display state in accordance with the instruction from the input and output unit 183. In FIG. 2, even though the external playback device 181 and the log connection server device 141 are directly connected, but the external playback device 181 and the log connection server device 141 may be connected through the network 161. Further, the contents or the operation log of the web page or the document structure associated with the operation log may be received from other device such as the web server device 121.

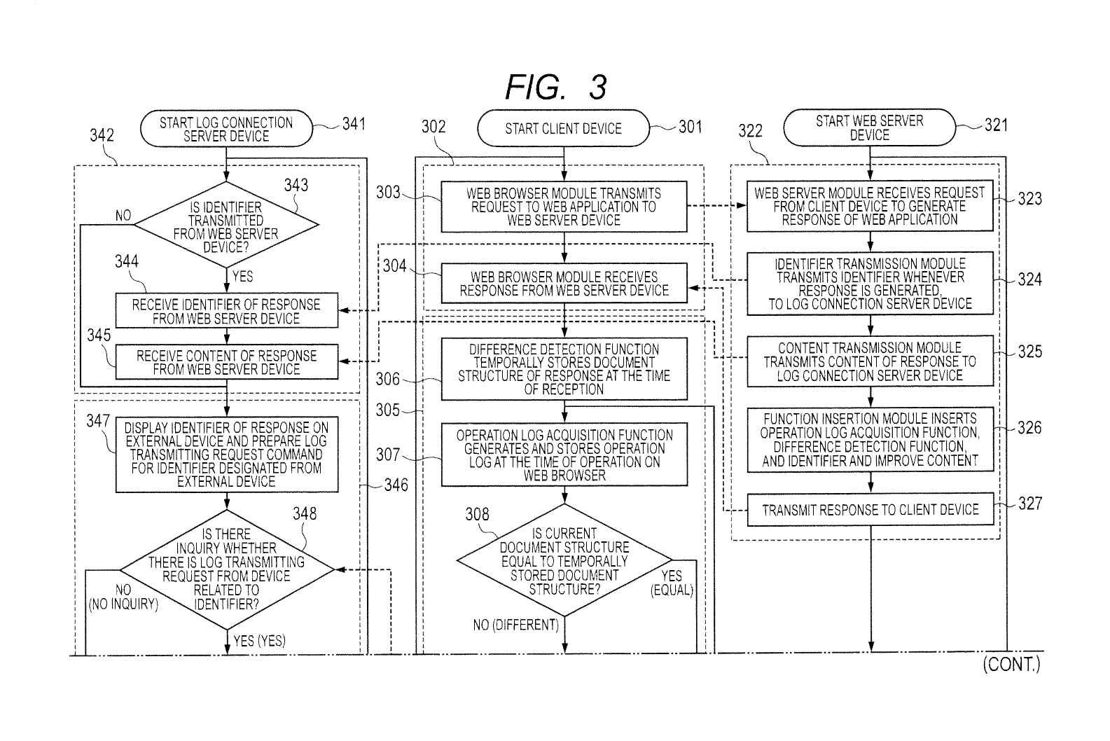

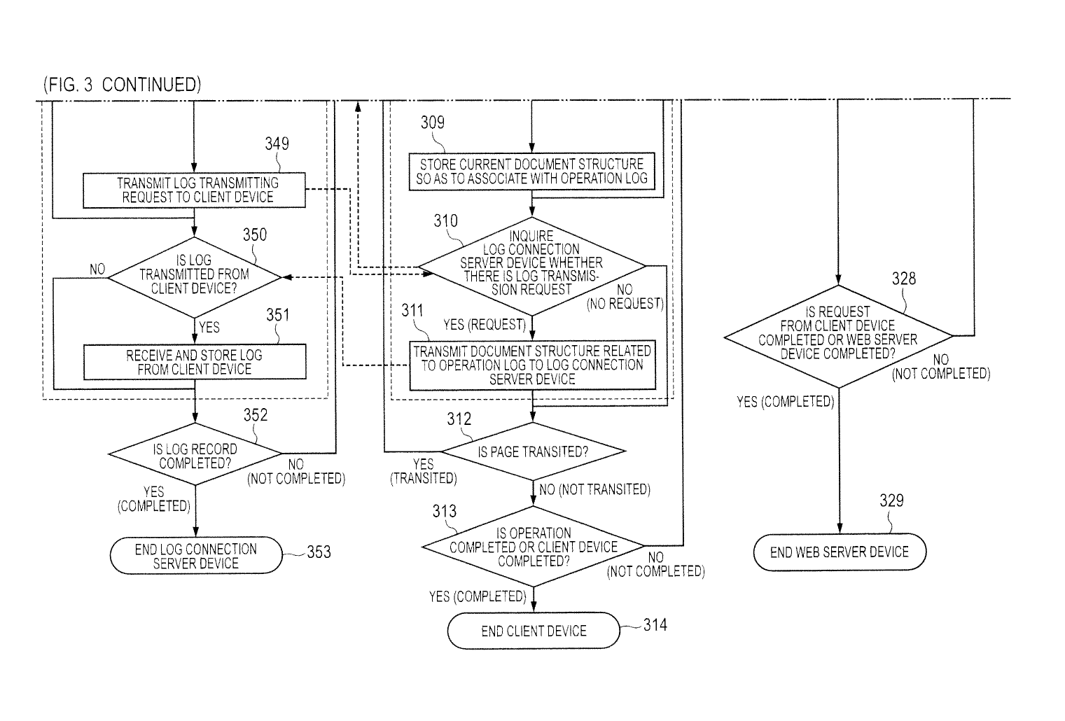

Next, with the above-mentioned system configuration and the operation reproduction of the web application as premises, a processing flow of the operation reproducing method of the web application according to the first embodiment will be described with reference to FIGS. 3 to 5 and FIGS. 11 to 16.

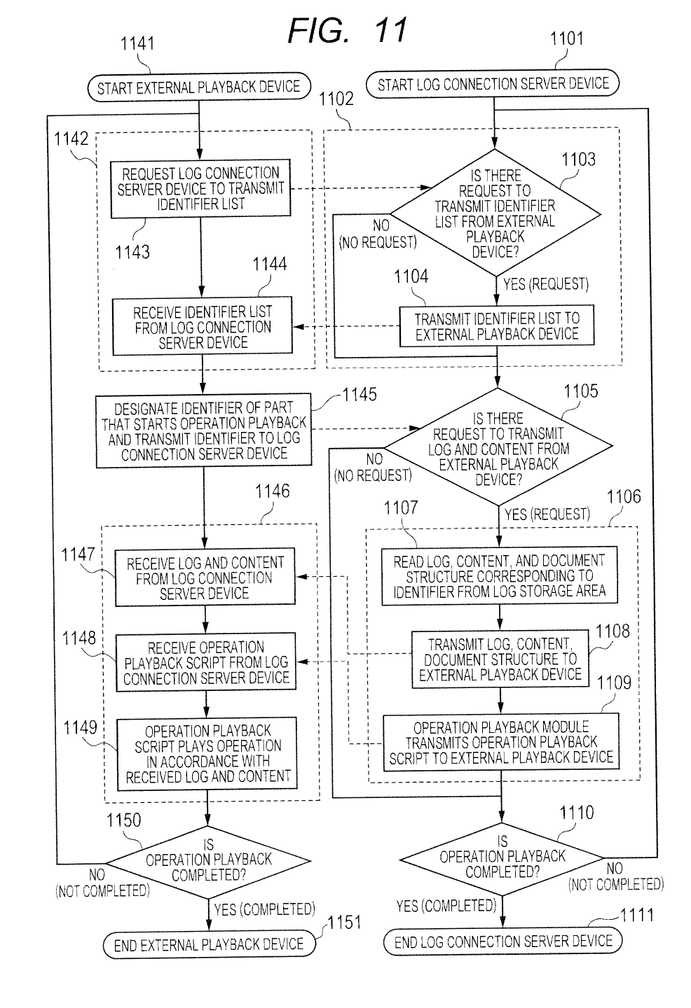

FIG. 3 illustrates a processing flow of the operation recording and FIG. 11 illustrates a processing flow of the operation reproducing. The processing flows illustrated in FIGS. 3 and 11 may be sequentially switched or simultaneously performed.

As illustrated in FIG. 3, the web browser module of the client device transmits the request to the web application to the web server device (step 303). In the web server device, the web server module receives the request from the client device to generate a response of the web application (step 323). The identifier transmission module transmits the identifier to the log connection server device whenever the response is generated (step 324). The identifier is a unique value for every response and is used to specify the contents of the web page of the response, the operation log of the operation performed on the web page, or the document structure associated with the operation log.

Continuously, the content transmission module transmits the contents of the response to the log connection server device (step 325). Further, the function insertion module inserts the operation log acquisition function, the difference detection function, and the identifier and improves the contents (step 326). The order of steps 324 to 326 is not limited to the order illustrated in FIG. 3, but the steps may be performed in a reverse order or simultaneously performed. Finally, the response is transmitted from the web server device to the client device (step 327). A series of the processings of the steps 323 to 327 are a flow of the processing that by the web server device according to this embodiment, generates the web page and hereinafter, will be referred to as step 322 all together. The web server device completes the processing if the request from the client device is completed or the web server device is completed (steps 328 and 329).

Continuously, the client device receives the response from the web server device (step 304). A series of processings of steps 303 and 304 in the client device are a flow of the processing that displays the web page in the client device and will be referred to as step 302 all together.

In the processing flow of FIG. 3, the log connection server device determines whether the identifier is transmitted from the web server device (step 343). If the identifier is transmitted, the identifier and the contents are received and stored (step 344 and 345). Hereinafter, the communication processing with the web server device will be referred to as step 342 all together. Continuously, in the log connection server device, a list of the stored identifiers is generated and the list is displayed on the external device and a command that transmits the operation log on the web page associated with the identifier specified by the external device is prepared (step 347).

The reception of the operation log that uses the command is performed by the following processing flow. First, step 302 is completed. In the client device in which the display of the web page is completed, the document structure which is included in the response used to display the web page or provide the function is temporally stored on the memory or the local disk by the difference detection function (step 306). Next, by the operation log acquisition function which is included in the response, the operation log of the operation performed on the web browser is generated to be stored on the memory or the local disk (step 307). When the operation log is generated, a current document structure is compared with a document structure which is temporally stored in step 306 (step 308). As a result of comparison, if the document structures are different, the document is associated with the operation log stored in step 307 and the current document structure is stored on the memory or the local disk (step 309). As a result of comparison in step 308, if the document structures are not different, step 309 is not performed.

Continuously, the operation log acquisition function inquires of the log connection server device whether there is a log transmission request (step 310). In this case, an identifier which may specify the client device or a displayed web page is transmitted to the log connection server device. If the log connection server device receives the inquiry about whether there is the log transmission request from the client device, it is determined whether the inquiry is an inquiry from an object that transmits the command prepared in step 347 (step 328). If the inquiry is the inquiry from the object, the command prepared in step 347 is transmitted to the client device (step 349). If the client device receives the command, the client device transmits the operation log specified by the command or the document structure associated with the operation log to the log connection server device (step 311). If the log is transmitted from the client device (step 350), the log connection server device receives and stores the log (step 351). Among a series of flows of the reception processing of the operation log, hereinafter, a processing flow at the log connection server device side is referred to as step 346 and a processing flow at the client device side are referred to as step 305 all together.

Further, in some cases, even when the identifier received from the client device does not match with the identifier specified in step 347, in the determination processing in step 348, it is determined that there is a corresponding inquiry and step 349 is performed. For example, if an identifier stored in the log connection server device includes a user identifier that may specify a user who performs an operation, the identifier transmitted from the client device does not include the user identifier, but includes a request identifier that has a unique value for every request of the web page, and thus an identifier of a user that transmits the request so as to be associated with the request identifier from the list of the identifier stored in the log connection server device is present, it is determined that there is an inquiry from the same user and an inquiry source has an operation log related to the identifier specified in step 347 and the command is transmitted.

As described above, in the log connection server device, by managing the list of the identifier, the log connection server device acquires the contents or the operation log of the web page which have been displayed and operated in the past. Further, the determination processing of step 348 is omitted and a command for the inquiry about whether there is the log transmission request from the client device is always transmitted. Further, at the client device side, it is determined whether there is an operation log corresponding to the object of the command or a document structure associated with the operation log with the stored operation log or the document structure associated with the operation log, and the operation log or the document structure associated with the operation log may be transmitted to the log connection server device.

Finally, in the client device, if the page is transited, the sequence returns to step 302 and if the page is not transited, the operation is completed or if the client device is not completed, the sequence returns to step 305. Otherwise, the processing is completed (step 313).

Also in the log connection server device, if the log recording is not completed, the sequence returns to step 342. Otherwise, the processing is completed (step 353).

Further, a method of performing the management of the identifier, or the transmission request and transmission/reception of the operation log or the document structure associated with the operation log is not limited to a method by the above-described log connection server device, but other methods may be used.

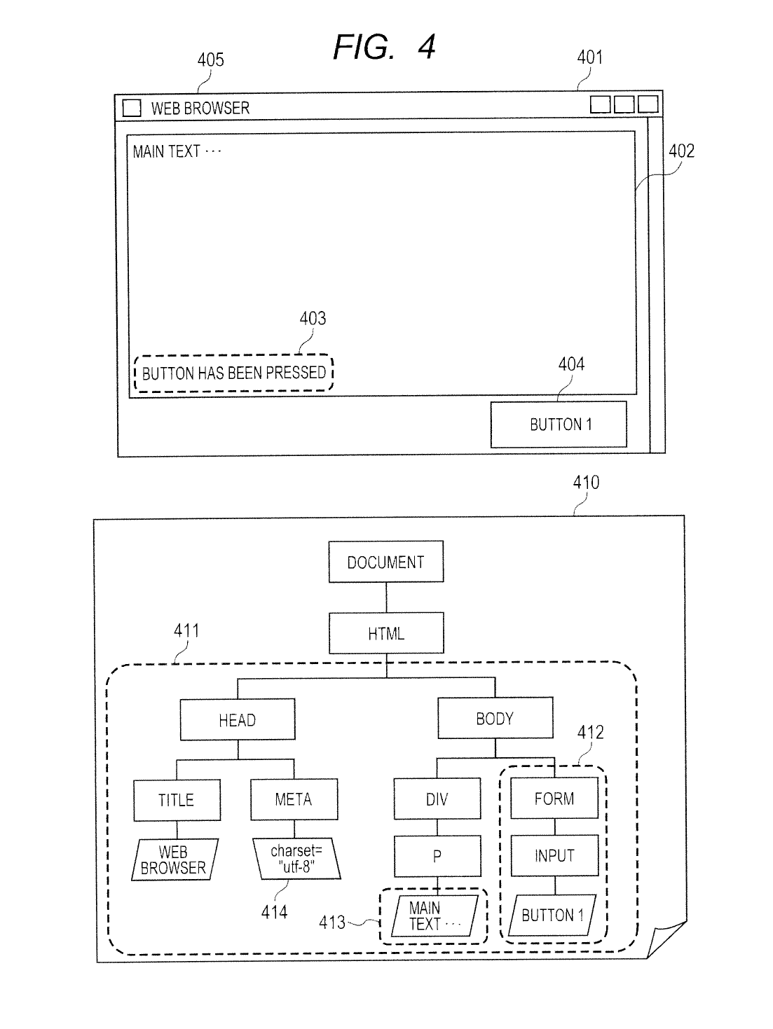

Next, referring to FIG. 4, a document structure which is recorded so as to be associated with the operation log will be described. An example that displays the web page on the web browser 401 and provides the function is illustrated in the upper part of FIG. 4. In this example, a message “main text . . . ” is displayed on the paragraph 402 and a button 1 is provided as an input 404. In this example, the button 1 provides a function that displays a message “button has been pressed” 403 on the paragraph if the button is pressed. In other words, by the clicking operation of the button 1, the display on the web browser 401 is dynamically changed at the client side.

In the lower part of FIG. 4, the document structure 410 of the web page is illustrated. Elements that configure the web page are hierarchized in a tree shape. In the example of FIG. 4, a DOCUMENT element is disposed at the top, HTML is below the DOCUMENT, and HEAD and BODY are continuous thereto below HTML and DOCUMENT. Below HEAD, TITLE and META are disposed and a character string of “web browser” which is a text element of TITLE is displayed in a title bar 405 of the web browser. META has an attribute value “charset=utf−8” and a character code of the web page is correspondingly set. The message displayed in the paragraph 402 becomes a text element 413 of a paragraph below BODY. Further, the button 1 is represented as a document structure at INPUT below FORM below BODY. In the example of FIG. 4, by pressing the button 1, the text element 413 of the paragraph is changed to be “main text . . . button has been pressed”. In the processing flow described with reference to FIG. 3, the difference of the document structures is detected and stored so that the situation which is dynamically changed at the client side is recorded. FIG. 4 merely illustrates an example of the document structure but, the document structure may be represented by other method.

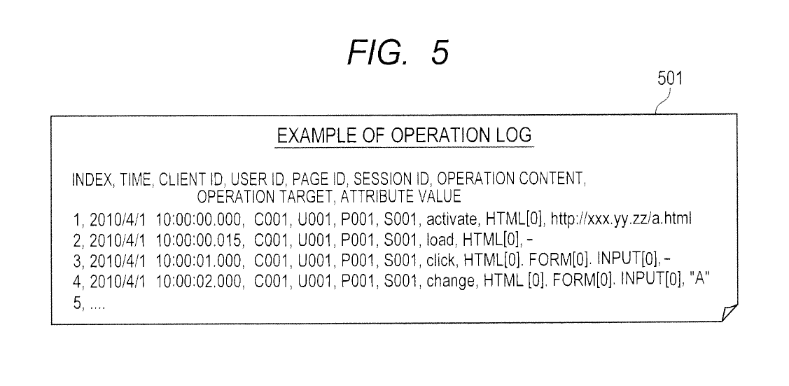

FIG. 5 is a view illustrating an example of the operation log. The operation log includes a time, a client ID, a user ID, a page ID, a session ID, an operation content, an operation target, and an attribute value. Among these, the operation target is recorded by the document structure illustrated in FIG. 4. For example, the operation log when the button 404 of FIG. 4 is pressed is recorded as HTML[0], FORM[0], or INPUT[0] as illustrated by an index 3 of an example of the operation log of FIG. 5, which indicates that a click operation is performed by a 0-th INPUT below a 0-th FORM below a 0-th HTML.

Next, referring to FIG. 11, a flow of the operation playback processing of the web application will be described. First, the external playback device requests the log connection server device to transmit an identifier list in order to select a target of the operation playback (step 1143). If the transmission request of the identifier list from the external playback device is received, the log connection server device generates and transmits a list of the stored identifier (step 1102). The external playback device receives the identifier list to display the identifier list (step 1144). Hereinafter, steps 1143 and 1144 are referred to as step 1142 all together. Next, the external playback device selects a part that plays back the operation from the identifier list and transmits the part to the log connection server device (step 1145). Even though the selection method may be varied depending on information included in the identifier, for example, an operation of a specific user may selectively become an operation target or an operation on a specific web page may selectively become an operation target. If the log connection server device receives the transmission request of a log or a content from the external playback device (step 1105), the log connection server device reads the operation log corresponding to the specified identifier or a document structure associated with the operation log or the content from the log storage area (step 1107) and transmits the operation log, the document structure, and the content to the external playback device (step 1108).

Continuously, the operation playback module transmits a function that plays back an operation state on the web page such as the operation playback script to the external playback device (step 1109). Hereinafter, steps 1107 to 1109 are referred to as step 1106 all together. The log connection server device repeats these processings until the operation playback is completed. The external playback device receives the operation log, the document structure associated with the operation log, the content, and the operation playback script from the log connection server device (steps 1147 and 1148) and plays back the operation state on the web page from the received operation log, document structure associated with the operation log, and content using the operation playback script (step 1149). The operation state is played by displaying the content and further performing the operation in accordance with the operation log or displaying the operation content. When the operation recorded in the operation log is performed, the document structure of the content is updated or substituted in accordance with a document structure recorded so as to be associated with the operation log to play the state of the web page which is dynamically changed at the client side. Hereinafter, steps 1147 to 1149 are referred to as step 1146 all together. These processings are repeated until the playback of the operation is completed.

As described above, by the processings illustrated in FIGS. 3 to 5, and 11, the reproduction of the operation on the web page is achieved. These processings do not need to introduce a web browser program of the client device and a specific program other than a script engine program which is loaded therein or associated therewith but selectively collect the log or the content of a part of the operation to be played by the selection according to the identifier to play the part of the operation, records the change of the document structure, and plays back the state of the web page which is dynamically changed at the client side based on the recorded change of the document structure to improve the reproducibility of the operation.

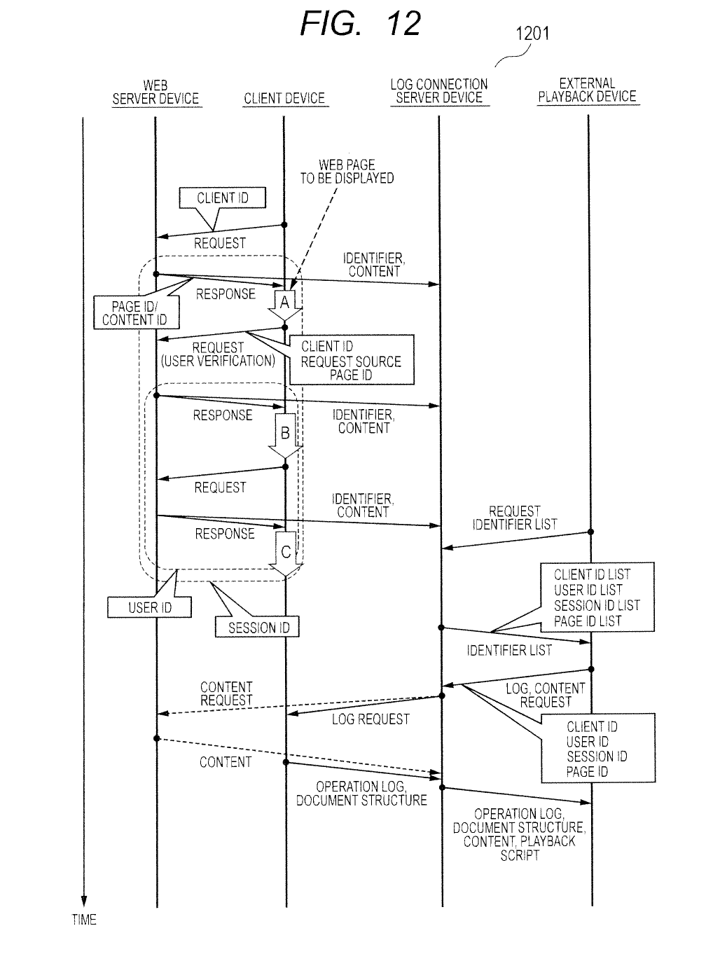

FIG. 12 is a view illustrating a sequence 1201 of the processing flow described with reference to FIGS. 3 and 11.

The processings for request of the web page, generation, transmission and reception, and display of the response, and recording and playback of the operation log, and the document structure have been described with reference to FIGS. 3 and 11. Here, an ID which becomes a candidate to be set as an identifier and the others which have not been described will be described.

As the candidate of the identifier, the client ID, the page ID, the content ID, the request source page ID, the session ID, and the user ID are included.

The client ID is an identifier that specifies the client device that sends the request to the web page and specifically includes a network address of the client device, a machine name, a process number of the web browser, or a hash value related thereto as an example. The client ID may be generated and acquired by the client device and transmitted to the web server device so as to be attached to the request.

The page ID is a unique identifier for every web page generated by the web server device. Specifically, an example of the page ID includes a value which is created by combining a URL of the page, a generation time, or the network address of the web server device by the web server device. The page ID may be the same URL or a separate page ID in the case of a web page generated by a separate request.

The request source page ID is a page ID of a web page that generates a request to a next web page when transition to a next webpage occurs on the web page by a link or a button. The request source page ID and a new page ID are recorded as a set so that the page transition state may be recorded.

The content ID is an identifier which is similar to the page ID. The page ID is an identifier which is assigned in the unit of a web page. In contrast, the content ID is an identifier which is also assigned to data such as an image or a script code but not limited to an HTML document of the web page. In the case of a static image which is not changed, if the image is requested by a separate request, but is the same image, the same content ID may be assigned thereto. By doing this, when the content is stored, since the content which is static and is not changed has the same content ID, the content does not need to be duplicatively stored.

The session ID is an identifier which is generally set by a web server device with respect to the transition of a series of web pages. In FIG. 5, web pages A, B, and C are transitions of a series of web pages so that a common session ID is assigned to the web pages A, B, and C. For example, when one job is completed by three pages of web pages A, B, and C, if it is desired to select the entire job to play the operation, it is convenient to select playback target by the session ID.

The user ID is an identifier that specifies a user who performs the operation that generates a request to the web page. Generally, the user ID is an identifier that is input by a user or set by a web server device after authentication when a user is authenticated. The user ID may be conveniently used when it is desired to playback the operation by the same user regardless of a time or a location.

As known from FIG. 12, since some identifiers may not be present depending on a timing, an identifier which is transmitted from the web server device to the log connection server device may be varied depending on the timing and there are identifiers which may be calculated even when all identifiers are not always transmitted.

Between the external playback device and the log connection server device, when a playback target of the operation is selected, first, the log connection server device transmits the list of the stored identifier. The list includes all or a part of candidates of the identifiers. The external playback device selects an identifier from the candidates so that the corresponding operation log, the document structure associated with the operation log, and the content are specified.

Even though not illustrated in FIG. 12, a method that allows the client device to assign an operation ID to an operation log which is generated whenever the operation is performed on the web page and the document structure recorded by the condition as an identifier, transmit the operation ID to the log connection server device similarly to the other identifiers and store the operation ID, and selects the operation ID by the external playback device is also included in this embodiment.

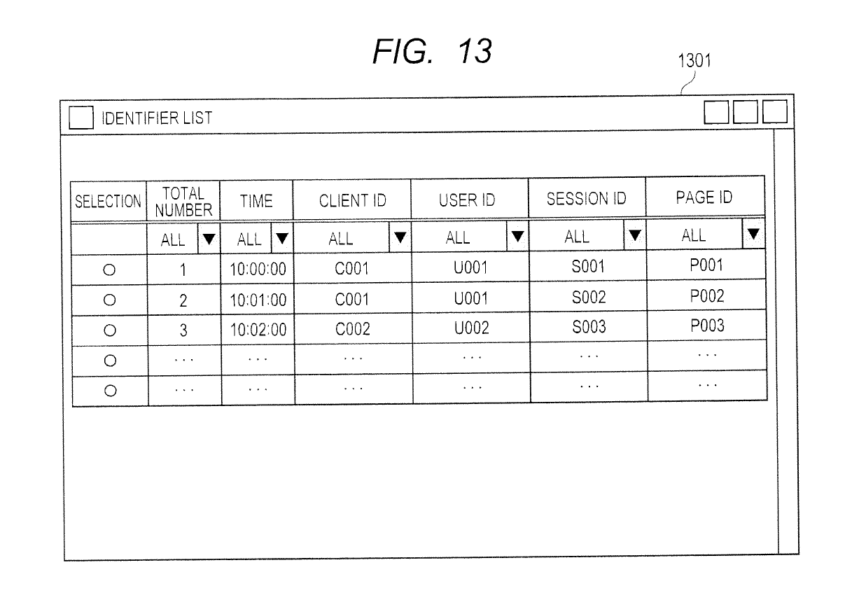

Reference numeral 1301 of FIG. 13 is an example of a web page that selects a web page which is an operation reproduction target in this embodiment.

Information that specifies a web page such as the time, the client ID, the user ID, the session ID, and the page ID is displayed in a form of list and a web page of the operation reproduction target is selected from the above information so that the information is used to display the list of the operations which are performed on the web page and reproduce the operation.

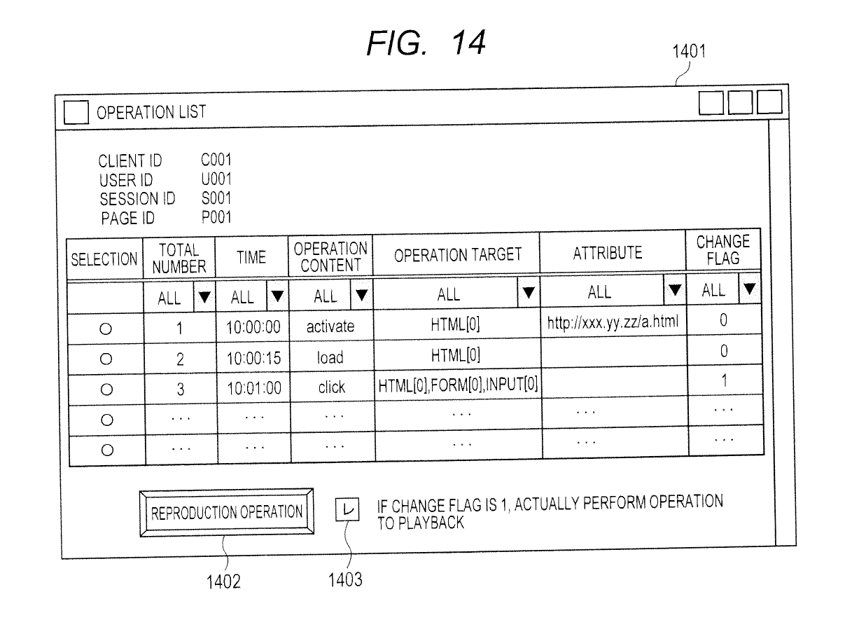

Reference numeral 1401 of FIG. 14 is an example of a web page that selects an operation of the operation reproduction target in this embodiment. Reference numeral 1401 displays the list of the operations which are performed on the web page specified by the web page 1301 that selects the web page illustrated in FIG. 13. The list includes the time, the operation content, the operation target, and the attribute. Further, a button 1402 that starts to reproduce the operation is also provided on the operation in the middle of operation, the selection which is at the left end of a row of the corresponding operation is clicked and then the button is pressed so that the operation is reproduced. Even though the list has an item of a change flag, the item is displayed as 1 when the document structure is recorded so as to be associated with the operation log. By doing this, it is possible to confirm that which operation causes the web page to be dynamically changed.

The check box 1403 is a check box that indicates to actually perform an operation whose change flag is 1 at the time of reproducing the operation. A method of reproducing the operation includes a method that actually performs and reproduces the operation and a method that reproduces only the display without actually performing the operation. The former method is effective to improve the reproducibility. However, by actually performing the operation, for example, a reverse effect which changes the state at the server side may be accompanied. In contrast, the latter method is a method that performs operation reproduction, for example, the motion of the mouse by moving an image imitating a mouse pointer. However, in this case, if it is not actually performed so that the web page is not dynamically changed, the reproducibility becomes lower. Therefore, the latter method is used as a basic reproduction method of the operation and only the operation in which the web page is dynamically changed is reproduced by the former method so that the reverse effect is restricted and the reproducibility is improved.

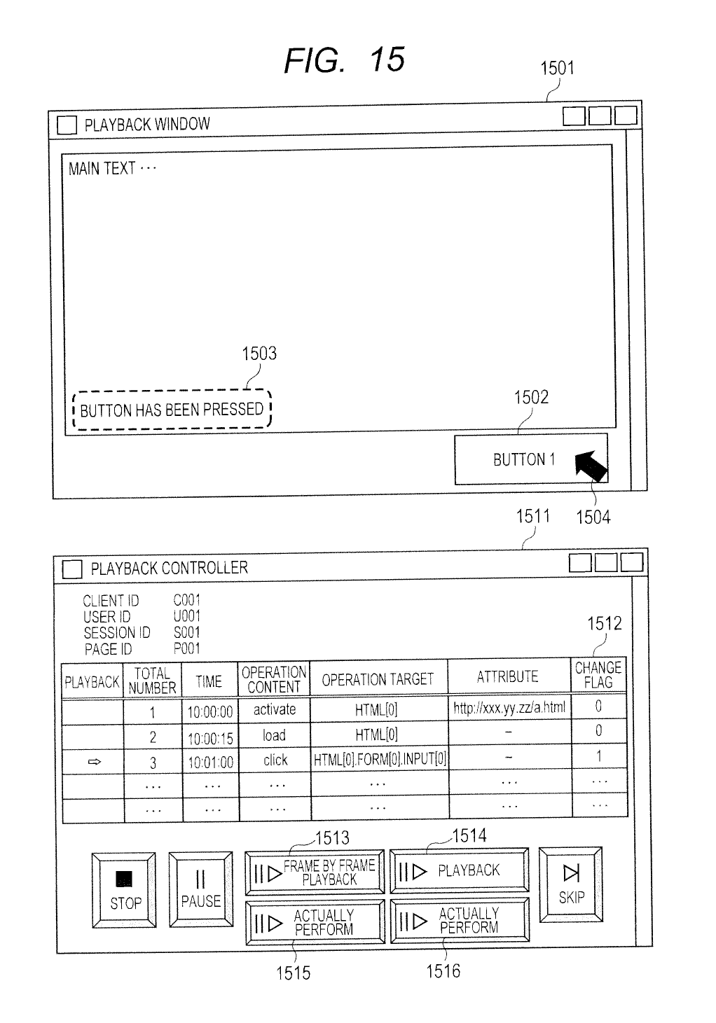

FIG. 15 is an example of the reproduction status of the operation and a web page that controls the operation reproduction. In a playback window 1501 which is illustrated in the upper part of the drawing, a mouse pointer 1504 reproduces an operation that presses a button 1502. A playback controller 1511, which is illustrated in the lower part of the drawing, provides a list 1512 of operations performed on the web page which is being reproduced and a control function that performs to start, complete or pause the reproduction by buttons. As the reproduction method of the operation, frame by frame playback 1513 that reproduces an operation one by one or playback 1514 that automatically and sequentially reproduces operations, and functions 1515 and 1516 that actually perform to reproduce the operation in various reproduction methods are provided. In the list 1512 of operations, a change flag is displayed similarly to FIG. 14 and the flag may be performed by a method that actually performs only one operation, but does not actually perform the other operations, except for the display. Specifically, one operation whose change flag is 1 is reproduced by using the button 1515 and the other operations are reproduced by using the button 1513.

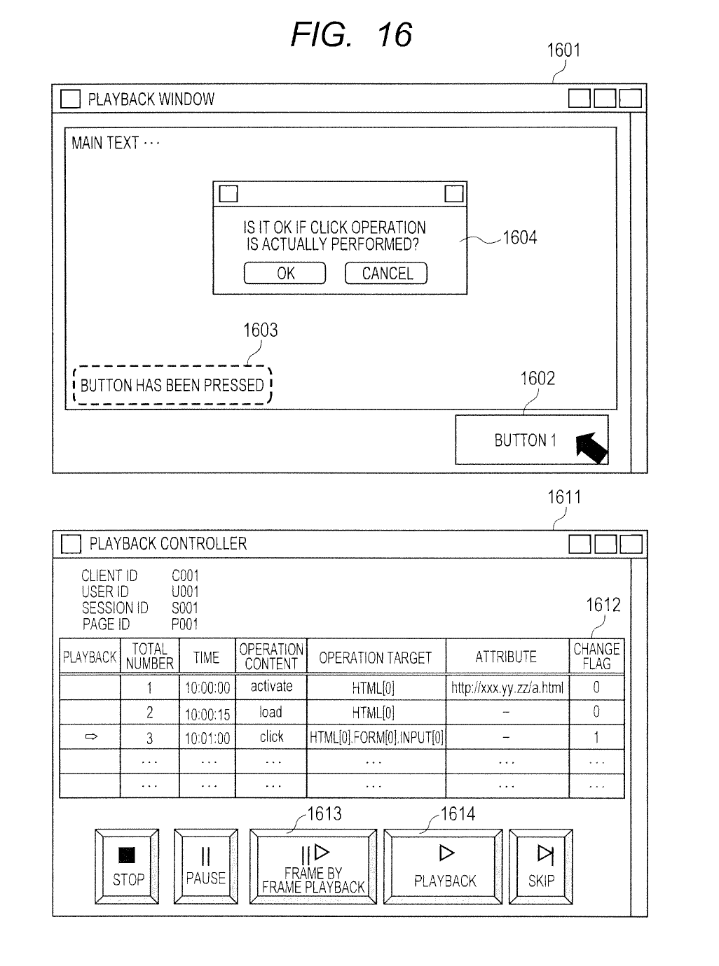

FIG. 16 is an example of the reproduction status of the operation and a separate web page that controls the operation reproduction. A playback window 1601 at the upper part and a playback controller 1611 at the lower part are substantially similar to those illustrated in FIG. 15. However, in the playback controller 1611, a function that specifies a reproduction method that is actually performed is not provided. When one operation whose change flag is 1 is reproduced, the change flag displays a message inquiring whether the operation is actually performed on the playback window 1601 or a separate window from the playback window so that a user may select the reproduction method.

According to the processing flow of the first embodiment described above, the operation on the client device and the dynamic change of the web page are continuously recorded so that the operation may be played with a high reproducibility.

### Second Embodiment

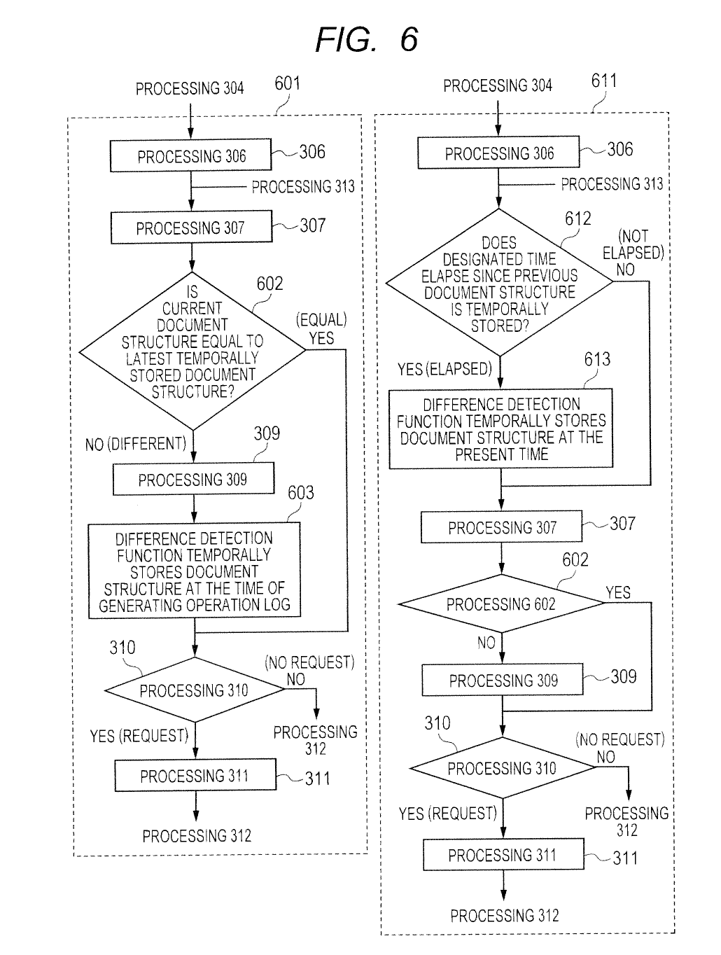

A second embodiment will be described with reference to FIG. 6. Here, only different parts from the first embodiment will be described and the parts which have been described in the first embodiment will be omitted.

FIG. 6 is a processing flowchart illustrating another embodiment for a difference detection method of a document structure by a difference detection function. A processing 601 at the left side of FIG. 6 and a processing 611 at the right side thereof correspond to the processing 305 of FIG. 3 and parts other than the processing 305 of FIG. 3 are the same as those of FIG. 3

In the processing 601, determination of change of a document structure is performed by determining whether a current document structure is equal to a latest document structure which is temporally stored (step 602). Further, if the document structure is changed, a changed document structure is temporally stored (step 603) and used to determine change of a next document structure. By doing this, if a lot of dynamic change of the web page occurs at the client side, it is possible to reduce the amount of stored document structures by the difference detection.

In the processing 611, by temporally storing the document structure at every designated time (step 613), determination of the change of the document structure is performed by determining whether the current document structure is equal to the document structure which is temporally stored at every designated time (step 612). By doing this, it is possible to improve the operation reproducibility even when the dynamic change of the web page occurs at the client side regardless of the operation.

### Third Embodiment

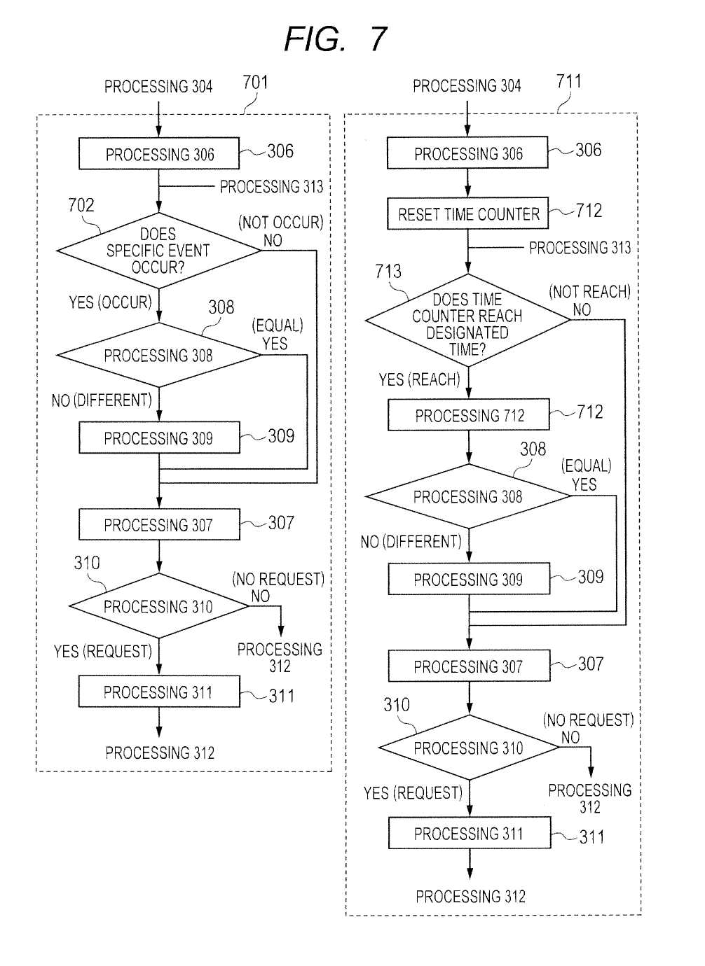

A third embodiment will be described with reference to FIG. 7. Here, only different parts from the first embodiment will be described and the parts which have been described in the first embodiment will be omitted.

FIG. 7 is a processing flowchart illustrating another embodiment for a difference detection timing of a document structure by a difference detection function. A processing 701 at the left side of FIG. 7 and a processing 711 at the right side thereof correspond to the processing 305 of FIG. 3 and parts other than the processing 305 of FIG. 3 are the same as those of FIG. 3.

In the processing 701, the determination of the change of the document structure is performed only when a specific event occurs (step 702). For example, if it is known in advance that dynamic change of a web page which requires a reproducibility in the reproduction of the operation is likely to be generated only by clicking the mouse, the storage of the document structure at the time of generating all operation logs is restricted to a case when an event that clicks the mouse occurs, so that an amount of resources which are required for the storage may be reduced. By doing this, likes a banner advertisement that dynamically changes, if the web page includes a part which is not related to the basic function on the web page but dynamically changed, storage of an unnecessary document structure may be prevented.

In the processing 711, the determination of the change of the document structure is performed at every designated time so that the dynamic change of the web page may be recorded regardless of the presence of the operation or the event. By doing this, contrary to the processing 701, it is possible to improve reproducibility of a web page including a content such as a banner advertisement which is dynamically changed at every predetermined time.

### Fourth Embodiment

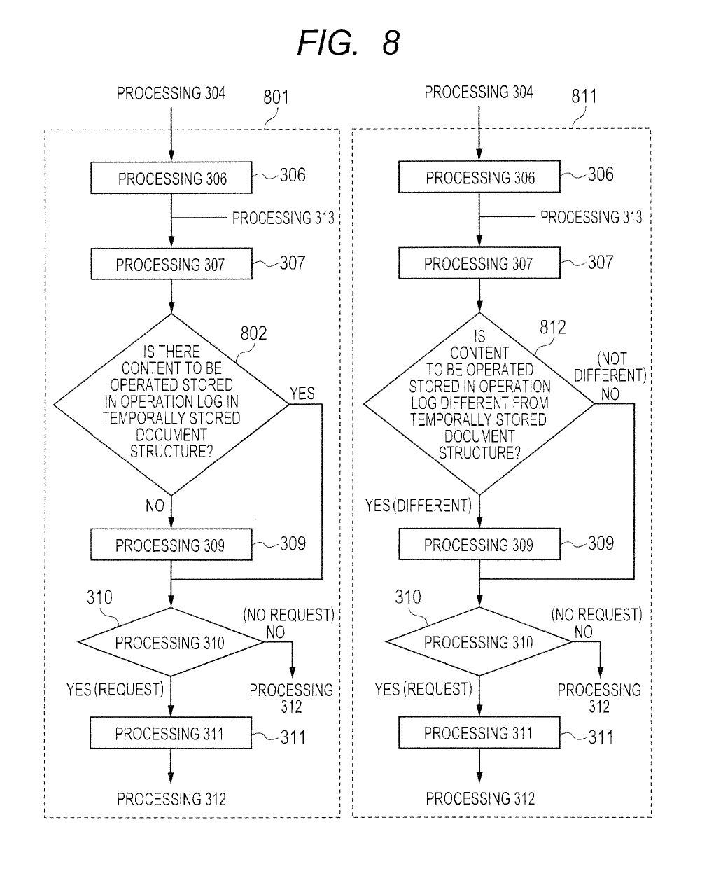

A fourth embodiment will be described with reference to FIG. 8. Here, only different parts from the first embodiment will be described and the parts which have been described in the first embodiment will be omitted.

FIG. 8 is a processing flowchart illustrating another embodiment for a difference detection method of a document structure by a difference detection function. A processing 801 at the left side of FIG. 8 and a processing 811 at the right side thereof correspond to the processing 305 of FIG. 3 and parts other than the processing 305 of FIG. 3 are the same as those of FIG. 3.

In the processing 801, the determination of the change of the document structure is performed by determining whether the content to be operated stored in the operation log is included in the temporally stored document structure (step 802). By doing this, when the operation target is dynamically generated, it is possible to prevent a phenomenon that the operation is not reproduced because there is not an operation target or the reproduction of the operation causes an error. Further, if the document structure is large sized, the determination of the change of the document structure by the difference detection function may be performed with a small amount of throughput.

In the processing 811, the determination of the change of the document structure is performed by determining whether the document structure of the content to be operated is changed (step 812). By doing this, for example, even though the operation target is present on the document structure, if an attribute thereof which is not visualized as “hidden” is visualized to be changed so as to be operated, it may be determined that the document structure is changed. Similarly to the processing 801, even though the document structure is large sized, the determination of the change of the document structure by the difference detection function may be performed with a small amount of throughput.

### Fifth Embodiment

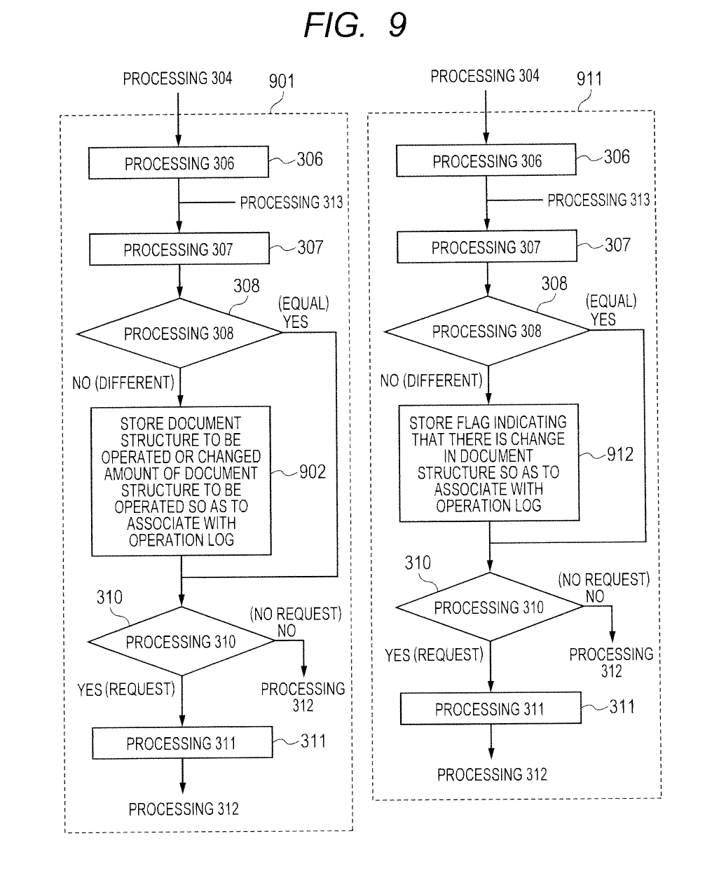

A fifth embodiment will be described with reference to FIG. 9. Here, only different parts from the first embodiment will be described and the parts which have been described in the first embodiment will be omitted.

FIG. 9 is a processing flowchart illustrating another embodiment for a difference storage method of a document structure by a difference detection function. A processing 901 at the left side of FIG. 9 and a processing 911 at the right side thereof correspond to the processing 305 of FIG. 3 and parts other than the processing 305 of FIG. 3 are the same as those of FIG. 3.

In the processing 901, as difference of the document structure, the document structure to be operated or a changed amount of the document structure to be operated are stored (step 902). By doing this, it is possible to reduce the resource amount which is required to store the document structure while maintaining a reproducibility of the content to be operated which is directly related to the reproduction of the operation.

In the processing 911, when the document structure is changed, only a fact that the document structure is changed is stored as a flag (step 912). By doing this, it is possible to reduce an amount of absence resource due to the storage of the document structure. At the time of reproducing the operation, it is an efficient storage method when the reproducibility of the operation is improved by actually performing the operation in which the flag is built to reproduce the operation.

### Sixth Embodiment

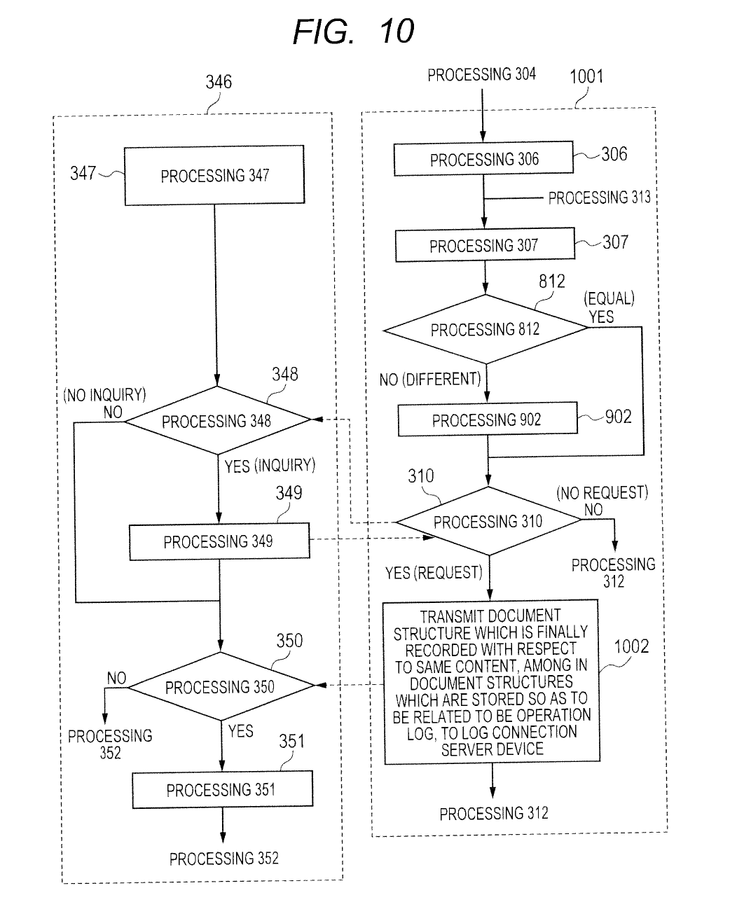

A sixth embodiment will be described with reference to FIG. 10. Here, only different parts from the first embodiment will be described and the parts which have been described in the first embodiment will be omitted.

FIG. 10 is a processing flowchart illustrating another embodiment for a difference transmission method of a document structure by a difference detection function. A processing 1001 of FIG. 10 corresponds to the processing 305 of FIG. 3 and parts other than the processing 305 of FIG. 3 are the same as those of FIG. 3.

In the processing 1001, when the log transmission request is sent from the log connection server device to the client device, among the document structures which are transmitted together with the operation logs and stored with respect to the same content, only a document structure which is finally recorded is transmitted (step 1002). By doing this, it is possible to reduce the amount of data which is transmitted from the client device to the log connection server device. At the time of reproducing the operation, a reproducibility in the middle of a series of operations may be reduced, but the reproducibility in the final state is substantially equal to the other embodiments.

### Seventh Embodiment

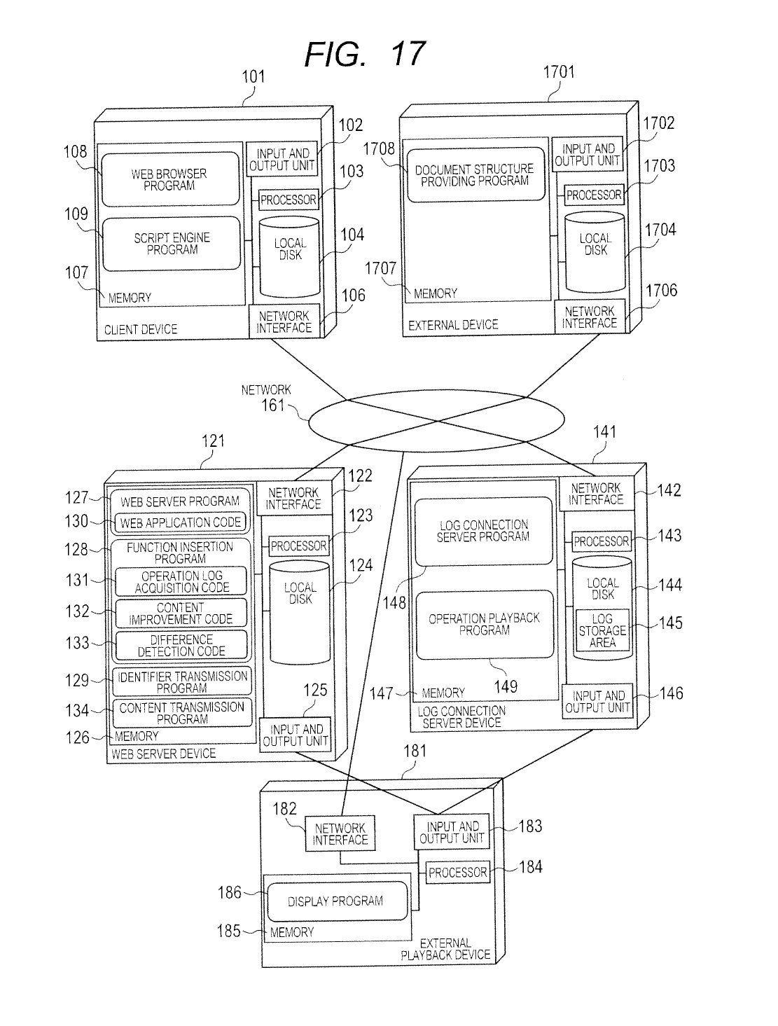

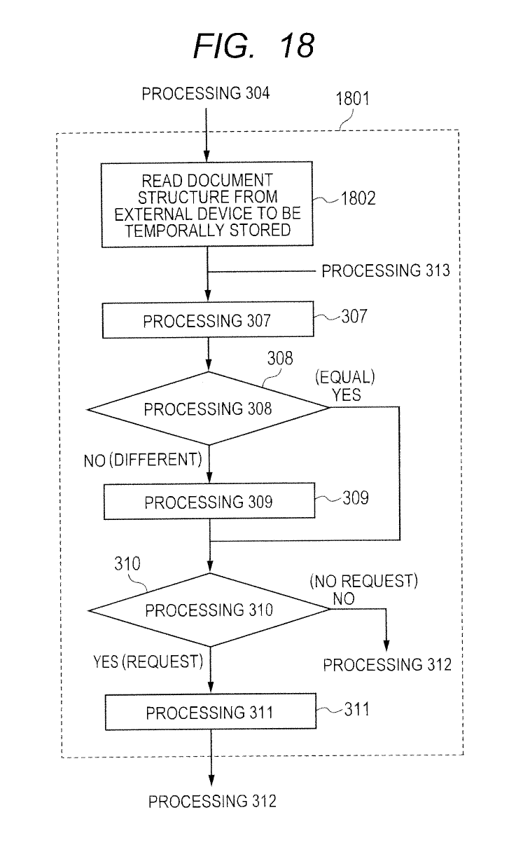

A seventh embodiment will be described with reference to FIGS. 17 and 18. Here, only different parts from the first embodiment will be described and the parts which have been described in the first embodiment will be omitted.

FIG. 17 is an example of a system configuration that executes the web application according to this embodiment. An external device 1701 has a computer configuration configured by a processor 1703 which has the same function as the client device 101 or the web server device 121, a memory 1707, an input and output unit 1702, a local disk 1704, and a network interface 1706.

A document structure providing program 1708 is stored on the memory 1707 and the document structure providing program 1708 is a program that provides a function that transmits a response specified from the other device through the input and output unit 1702 or the network interface 1706, or the document structure in the middle of the operation on the client to the other device through the network interface 1706 in accordance with the request. The external device 1701 may be the same as the web server device 121 or the log connection server device 141, and for example, the document structure providing program 1708 may be present on the web server program 127 of the web server device 121 and the web server device 121 may provide the same function.

FIG. 18 is a flowchart illustrating an example of a processing that records the operation by a system that includes the external device 1701 having the document structure providing program 1708 according to this embodiment. A processing 1801 of FIG. 18 corresponds to the processing 305 of FIG. 3 and parts other than the processing 305 of FIG. 3 are the same as those of FIG. 3.

In the processing 1801, the document structure of the web page is read from the external device 1701 and temporally stored (step 1802). Using the temporally stored document structure, the document structure is changed or stored. By doing this, for example, if the client device receives a response from the web server device and the web page is dynamically changed before the difference detection function is operated, the document structure providing program 1708 transmits the document structure of the web page before the web page is dynamically changed, which is included in the response so as to precisely record dynamic change of the document structure.

As described above, even though various embodiments according to the present invention have been described, it is needless to say that an arbitrary combination of the first to seventh embodiments is also included in the present invention. For example, the web browser of the client device performs the difference detection function and compares the content that forms the document structure of the web page with a content of a first document structure. If there is a difference, the difference is stored so as to be associated with the operation log. By considering a document having a difference as a new first document, the stored difference is transmitted to the log connection server device so that only the difference of the content which is finally stored is transmitted. Further, the first to seventh embodiments describe only examples. For example, the operation is recorded while reproducing the operation by combining the embodiments of the present invention. Further, as information which may be included in the operation log or the document structure associated with the operation log, all information which may be recorded on the web browser may be included. Further, even though the description is made under the assumption that each of all the devices is one, the device may be plural or a plurality of devices may be combined by a smaller number of devices.

### INDUSTRIAL APPLICABILITY

The present invention is efficient as a processing technology that records, stores, and reproduces the operation of the web application.

### REFERENCE SIGN LIST

101 Client device
102, 125, 146, 183, 1702 Input and output unit
103, 123, 143, 184, 1703 Processor
104, 124, 144, 1704 Local disk
106, 122, 142, 182, 1706 Network interface
107, 126, 147, 185, 1707 Memory
108 Web browser program
109 Script engine program
121 Web server device
127 Web server program
128 Function insertion program
129 Identifier transmission program
141 Log connection server device
145 Log storage area
148 Log connection server program
149 Operation playback program
161 Network
181 External playback device
186 Display program
1701 External device
1708 Document structure providing program

1. An operation reproduction method of a web application in a system configured by a web server, a web browser, a log connection server that stores an operation log on the web page, and a network that couples the web server, the web browser, and the log connection server to each other, the method comprising:
by the web server, inserting an operation log acquisition function that operates on the web browser and a difference detection function that detects and stores change of a document structure of the web page into the web page and transmitting the functions when the generated web page is transmitted to the web browser,
by the web browser, performing the received difference detection function inserted into the web page, to store the document structure of the web page as a first document structure,
performing the operation log acquisition function to generate and stores the operation log on the web page, and
performing the difference detection function to compare the document structure of the web page with the first document structure and if there is a difference, storing the difference so as to be associated with the operation log, and
by the log connection server, reproducing the operation using the stored operation log and the difference which is stored to be associated.

2. The operation reproduction method according to claim 1, wherein if there is a difference, the difference detection function stores the document structure having the difference so as to be associated with the operation log.

3. The operation reproduction method according to claim 2, wherein the difference detection function uses the difference from the first document structure as the document structure which is stored so as to be associated with the operation log.

4. The operation reproduction method according to claim 2, wherein if a content to be operated among contents that form the document structure is different from a content stored in the first document structure, the difference detection function stores the difference of the contents so as to be associated with the operation log.

5. The operation reproduction method according to claim 4, wherein when the web browser transmits the difference of the content which is stored so as to be associated with the operation log to the log connection server, only a difference of a content which is finally stored among the differences for the contents is transmitted.

6. The operation reproduction method according to claim 1, wherein when the document structure having a difference is stored so as to be associated with the operation log, if the operation of the stored operation log is reproduced and displayed, the log connection server represents that the document structure has a difference.

7. The operation reproduction method according to claim 1, wherein when the document structure having a difference is stored so as to be associated with the operation log, if the operation of the stored operation log is reproduced, the log connection server actually performs the operation to perform the reproduction.

8. The operation reproduction method according to claim 7, wherein before actually performing the operation to perform the reproduction, the log connection server checks whether the operation is allowed to be actually performed.

9. The operation reproduction method according to claim 1, wherein as a result of the comparison by the difference detection function, if there is a difference, the compared document structure is considered as the first document structure.

10. The operation reproduction method according to claim 1, wherein the document structure of the web page is acquired from an outside of the web browser and the acquired document structure is considered as the first document structure.

11. An operation reproduction system of a web application that reproduces an operation of a web application, the system comprising:
a web server device, a client device that executes a web browser, a log connection server device that stores an operation log on the web page, and a network that connects the web server device, the client device, and the log connection server device to each other,
wherein the web server device inserts an operation log acquisition function that operates on the web browser and a difference detection function that detects and stores change of a document structure of the web page and transmits the functions when the generated web page is transmitted to the web browser,
the web browser of the received client device performs the difference detection function inserted in the web page to store the document structure of the web page as a first document structure,
performs the operation log acquisition function to generate and store the operation log on the web page,
perform the difference detection function to compare the document structure of the web page with the first document structure and if there is a difference, stores the difference so as to be associated with the operation log, and
the log connection server device reproduces the operation using the stored operation log and the difference which is stored to be associated.

12. The operation reproduction system according to claim 11, wherein as a result of the comparison by the difference detection function, if there is a difference, the web browser of the client device stores the document structure having the difference so as to be associated with the operation log.

13. The operation reproduction system according to claim 12, wherein the web browser of the client device uses the difference from the first document structure as the document structure which is stored so as to be associated with the operation log.

14. The operation reproduction system according to claim 12, wherein if a content to be operated among contents that form the document structure is different from a content stored in the first document structure, the web browser of the client device stores the difference of the content so as to be associated with the operation log.

15. The operation reproduction system according to claim 14, wherein when the web browser of the client device transmits the difference of the content which is stored so as to be associated with the operation log to the log connection server, the web browser of the client device transmits only a difference of a content which is finally stored among the differences for the contents.

16. The operation reproduction system according to claim 11, wherein when the document structure having a difference is stored so as to be associated with the operation log, if the operation of the stored operation log is reproduced and displayed, the log connection server represents that the document structure has a difference.

17. The operation reproduction system according to claim 11, wherein when the document structure having a difference is stored so as to be associated with the operation log, if the operation of the stored operation log is reproduced, the log connection server actually performs the operation to perform the reproduction.

18. The operation reproduction system according to claim 17, wherein before actually performing the operation to perform the reproduction, the log connection server checks whether the operation is allowed to be actually performed.

19. The operation reproduction system according to claim 11, wherein as a result of the comparison by the difference detection function, if there is a difference, the web browser of the client device considers the compared document structure as the first document structure.

20. The operation reproduction system according to claim 11, wherein the web browser of the client device acquires the document structure of the web page from an external device connected to the network and considers the acquired document structure as the first document structure.
